(19) United States
(12) Patent Application Publication
(10) Pub. No.: US 2012/0307344 A1
(43) Pub. Date: Dec. 6, 2012

(54) ELECTRONIC PAPER DISPLAY DEVICE AND DISPLAYING METHOD

(75) Inventors: Jintong HAN, Beijing (CN); Lu QU, Beijing (CN)

(73) Assignee: BOE TECHNOLOGY GROUP CO., LTD., Beijing (CN)

(21) Appl. No.: 13/480,727

(22) Filed: May 25, 2012

(30) Foreign Application Priority Data
May 30, 2011 (CN) 201110143116.7

(51) Int. Cl. G02F 1/167

(52) U.S. Cl. 359/296

(57) ABSTRACT

The disclosed technology is related to an electronic paper display and a displaying method. The electronic paper display device comprises an upper substrate with a first conductive layer formed thereon, a lower substrate with a second conductive layer formed thereon, and an electronic ink layer disposed between the first conductive layer of the upper substrate and the second conductive layer of the lower substrate and comprising microcapsules arranged therein. A fluorescent material is further disposed between the upper substrate and the lower substrate, and in the region between the upper substrate and the lower substrate where it is capable of receiving irradiation of ambient light.

### BACKGROUND

Embodiments of the disclosed technology relates to an electronic paper display device and its displaying method.

An electronic paper displaying technique is one kind of displaying techniques and can work as a sheet of paper to achieve comfortable reading, be thin and portable, have flexibility and ultra low power consumption, and it has gotten wide attention and been used in the display region at present.

An electronic paper display device is a reflective-type display. As shown in FIG. 1, a conventional electronic paper display device comprises: an upper substrate 1 with a first conductive layer 11 disposed thereon, a lower substrate 2 with a second conductive layer 2 disposed thereon, and an electronic ink layer 3 disposed between the first conductive layer 11 and the second conductive 12. The electronic ink layer 3 comprises a number of microcapsules 31 in which white particles W and black particles B having opposite charges are enclosed. The white particles W having high reflexivity are used to display a bright state, and the black particles B having good light absorbability are used to display a dark state. An external electric field is applied across each of the microcapsules 31 by the first conductive layer 11 and the second conductive layer 21, and arrangements of the particles with different colors are changed in accordance with the electric field so as to present visual effect in black and white colors. Therefore, the electronic paper display device can display contents with ambient light and has no backlight source.

However, the existing electronic paper display device can not normally work when the ambient light disappears or becomes weak, that is, when the display is performed in a dark environment, since the electronic paper display device needs ambient light to display, which brings inconvenience to the user.

### SUMMARY

An aspect of the disclosed technology provides an electronic paper display device comprising an upper substrate with a first conductive layer formed thereon; a lower substrate with a second conductive layer formed thereon, and an electronic ink layer disposed between the first conductive layer of the upper substrate and the second conductive layer of the lower substrate and comprising microcapsules arranged therein, wherein a fluorescent material is further disposed between the upper substrate and the lower substrate, and the fluorescent material is disposed in a region between the upper substrate and the lower substrate where it is capable of receiving irradiation of ambient light.

Another aspect of the disclosed technology provides a displaying method of an electronic paper display device comprising: displaying with ambient light while fluorescent material disposed in the electronic paper display device receives irradiation of ambient light to store optical energy; and displaying with light generated due to the optical energy discharging from the fluorescent material when the ambient light become weak or disappears.

Further scope of applicability of the present disclosed technology will become apparent from the detailed description given hereinafter. However, it should be understood that the detailed description and specific examples, while indicating preferred embodiments of the disclosed technology, are given by way of illustration only, since various changes and modifications within the spirit and scope of the disclosed technology will become apparent to those skilled in the art from the following detailed description.

### BRIEF DESCRIPTION OF THE DRAWINGS

The disclosed technology will become more fully understood from the detailed description given hereinafter and the accompanying drawings which are given by way of illustration only, and thus are not limitative of the disclosed technology and wherein:

FIG. 1 is a schematic structural diagram of an electronic paper display device in the prior art.

FIG. 2 is a schematic structural diagram of an electronic paper display device according to one embodiment of the disclosed technology.

FIG. 3 is a schematic principle diagram of the displaying of electronic paper display device shown in FIG. 2.

FIG. 4 is a schematic structural diagram of an electronic paper display device according to one embodiment of the disclosed technology.

FIG. 5 is a schematic structural diagram of an electronic paper display device according to one embodiment of the disclosed technology.

FIG. 6 is a schematic structural diagram of an electronic paper display device according to one embodiment of the disclosed technology.

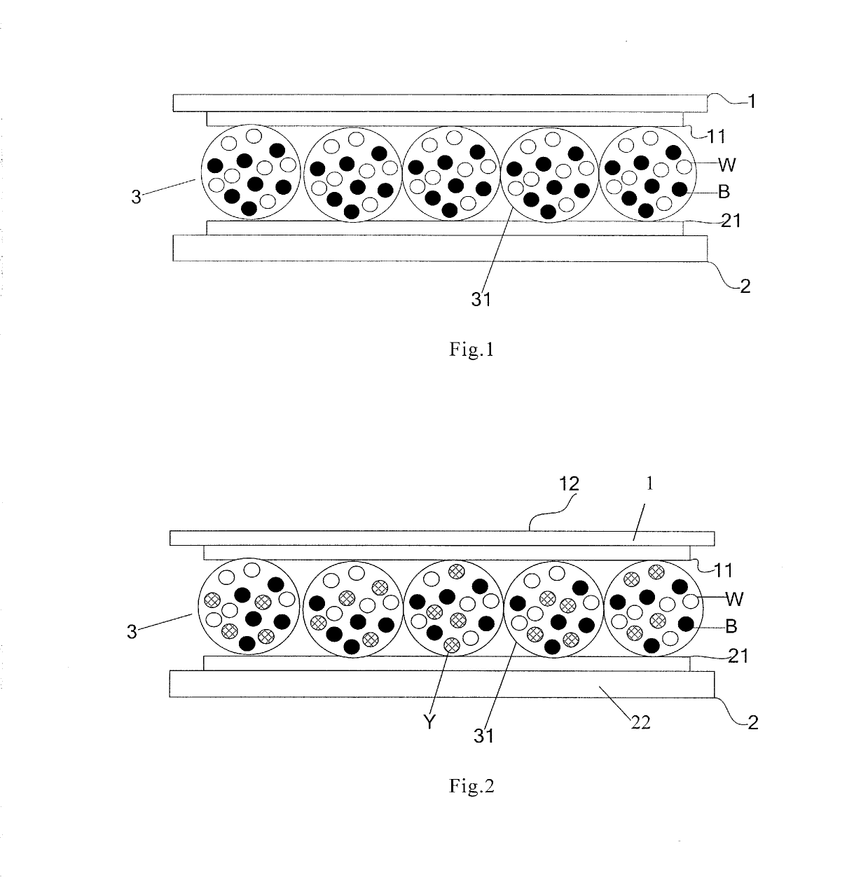

### DETAILED DESCRIPTION

One or more embodiments of the disclosed technology will be more clearly described by referring to the drawings, in which the embodiments of the disclosed technology is shown, in the following description.

It should be understood that the embodiments to be described are only part of the embodiments of the disclosed technology, instead of all the embodiments. Based on the embodiments described herewith, the other embodiments conceived by the skilled in the art without any creative work are within the scope claimed by the disclosed technology.

An embodiment of the disclosed technology provides an electronic paper display device comprising: an upper substrate with a first conductive layer, a lower substrate with a second conductive layer, and an electronic ink layer disposed between the first conductive layer of the upper substrate and the second conductive layer of the lower substrate and comprising microcapsules arranged therein. A fluorescent material, for example fluorescent powders, is further disposed between the upper substrate and the lower substrate. The fluorescent material is disposed in a region between the upper substrate and the lower substrate where it can be irradiated by ambient light.

The fluorescent material has the property to store optical energy upon receiving the irradiation of ambient light and gradually discharge optical energy stored therein in form of fluorescent light when ambient light become weak or disappears. The electronic paper display device according to the embodiment of the disclosed technology makes use of this property of the fluorescent material. The display performs display by using ambient light when ambient light is sufficient, and at the same time the fluorescent material receives the irradiation of ambient light to store optical energy; the display displays by using the fluorescent light emitted from the fluorescent material discharging the optical energy stored therein when the ambient light become weak or disappears. In this way, the electronic paper display provides a user with great convenience.

The electronic paper display devices according to embodiments of the disclosed technology are described in detail in the following, but is should be noted that the following embodiments are only used to explain the disclosed technology and the disclosed technology are not limited thereto.

FIG. 2 is an electronic paper display device according to an embodiment of the disclosed technology. As shown in FIG. 2, the electronic paper display of the present embodiment comprises: an upper substrate 1 comprising a base layer 12 which may be a transparent film such as a polyethylene terephthalate (PET) film and on which a first conductive layer 11 is formed, which is for example a transparent conductive layer such as indium tin oxide (ITO); a lower substrate 2 comprising a base layer 22 which may be a transparent film such as a polyethylene terephthalate (PET) film and on which a second conductive layer 21 is formed oppositely to the first conductive layer 11, which is for example a transparent conductive layer such as indium tin oxide (ITO); an electronic ink layer 3, also referred to as “microcapsule layer,” disposed between the first conductive layer 11 and the second conductive layer 21 of the substrates 1 and 2, and in which a plurality of microcapsules 31 are arranged for example in an array. Each microcapsule 31 contains a display particle dispersing solution therein and has white particles W and black particles B with opposite charges enclosed therein. The white particles W having high light reflexivity are used to display a bright state and may be titanium oxide particles for example; and the black particles B having high light absorbility are used to display a dark state and may be carbon black particles for example.

In the present embodiment, a fluorescent material (for example in a form of fluorescent particles) is further disposed between the upper substrate 1 and the lower substrate 2. In the present embodiment, the fluorescent powers or particles are enclosed within each of the microcapsules 31 and distributed in the display particle dispersing solution as well. As shown in FIG. 2, the fluorescent particles Y are enclosed within the microcapsules 31 together with the white particles W and the black particles B and may have the same charges as the white particles W or the black particles B. It depends on the displaying mode of the electronic paper display device of the present embodiment to decide which type of charge the fluorescent particles Y have; that is, when the electronic paper display device displays a white character on a black background, the fluorescent particles Y can have the same charges as the white particles W, while when the electronic paper display device displays a black character on a white background, the fluorescent particles Y can have the same charges as the black particles B. The fluorescent particles can be charged with the help of a charge controlling agent in the display particle dispersing solution or the like, and the disclosed technology does not limited the specific to charge the fluorescent particles.

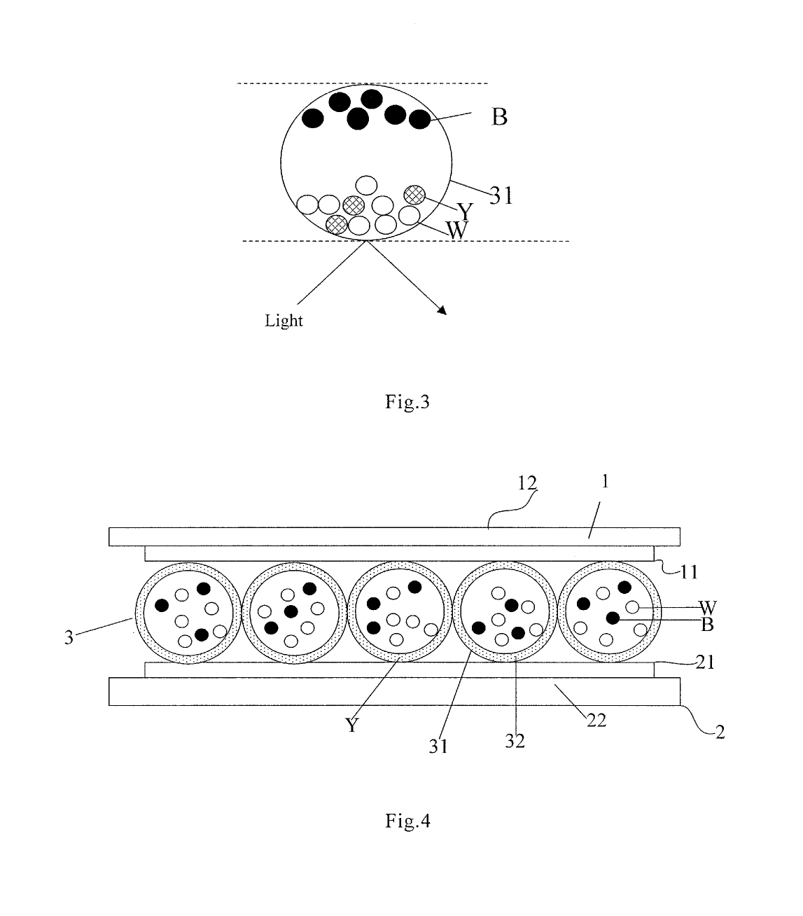

For example, when the electronic paper display device of the present embodiment displays a white character on a black background, the fluorescent particles Y has the same charges as the white particles W. It can be seen from FIG. 3, when the microcapsule 31 displays characters, the white particles W and the fluorescent particles Y are moved to the display side of the microcapsule 31 by electrophoresis upon the effect of an applied electrical field. When the electronic paper display device according to the present embodiment is in an environment with strong light, the white characters can be observed through the reflection of the light and the fluorescent particles Y can receive the irradiation of the ambient light such as sunshine, fluorescent lamp light, ultraviolet light and so on and stores optical energy therein. The fluorescent particles Y can gradually release the optical energy stored therein in fluorescent light form when the ambient light becomes weak and the reflection of light becomes relatively poor, and the electronic paper display device according to the present embodiment displays by using the light generated due to the release of such stored optical energy from the fluorescent particles Y and therefore it is convenient for a user.

In the present embodiment, the fluorescent powders enclosed within the microcapsule 31 preferably employ upconversion fluorescent powders which have high light transmittance efficiency and may not have any adverse effects on the displaying of microcapsule layer. In particular, the upconversion fluorescent powders in the present embodiment may have an average particle size of 30 nm and an excitation wavelength of 980 nm for example. It is obvious that other kind of fluorescent powders can also be used, and the present embodiment is not limited to this.

FIG. 4 shows another embodiment of the electronic paper display device according to the disclosed technology. As shown in FIG. 4, the present embodiment is different from the embodiment shown in FIG. 2 in that, in the present embodiment, the fluorescent powders disposed between the upper substrate 1 and the lower substrate 2 is particularly disposed within the capsule wall 32 of each microcapsule 31, that is, the fluorescent particles Y is distributed within the capsule wall 32, and the rest configuration is the same as that in the embodiment shown in FIG. 2.

When the electronic paper display device according to the present embodiment is in an environment with sufficient ambient light, it can display by using such ambient light, and at the same time the fluorescent powders disposed within the capsule wall 32 can receive the irradiation of the ambient light and stores optical energy therein. When the ambient light become weak or disappears, the fluorescent powder disposed within the capsule wall 32 can release the stored optical energy in fluorescent light form. Thus, the electronic paper display device according to the present embodiment can display by using the light generated due to the optical energy releasing from the fluorescent powder.

For example, the fluorescent powders can be doped in the material for forming the encapsulate wall 32 to form the capsule wall 32 with a fluorescent material and to form the microcapsule 31 by enclosing the display particle dispersing solution within the capsule wall 32.

In the present embodiment, the fluorescent powders are preferable water-soluble fluorescent powders so that the powders can be more evenly dispersed in the material for forming the capsule wall 32. Therefore, the displaying effect can be further improved with the electronic paper display device according to the present embodiment because the electronic paper display device displays by using the light generated due to the optical energy releasing from the fluorescent powders. It is obvious that other kind of fluorescent powders may also be used, and the present embodiment is not limited to this.

FIG. 5 shows another embodiment of the electronic paper display device according to the disclosed technology. As shown in FIG. 5, the present embodiment is different from the embodiment shown in FIG. 2 in that, in the present embodiment, the fluorescent material disposed between the upper substrate 1 and the lower substrate 2 is particularly in a layer disposed between the base layer 12 of the upper substrate 1 and the first conductive layer 11, and the rest configuration is the same as that in the embodiment shown in FIG. 2.

In the present embodiment, the fluorescent material (e.g., fluorescent powders) layer 5 is disposed between the base layer 12 and the first conductive layer 11. When the electronic paper display device according to the present embodiment is in an environment with sufficient ambient light, it can display by using the ambient light, and at the same time the fluorescent material layer 5 receives the irradiation of the ambient light and stores optical energy therein. When the ambient light become weak or disappears, the fluorescent material layer 5 discharges optical energy in fluorescent light form, and the electronic paper display device according to the present embodiment can display by using the light generated due to the optical energy discharging from the fluorescent material layer 5.

For example, the fluorescent material layer 5 may be disposed on the base layer 12 by spreading, coating, screen printing or the like.

In the present embodiment, the fluorescent material preferably employs upconversion fluorescent powders which have high light transmittance efficiency and may not have any adverse effect on the displaying effect of the microcapsule layer. It is obvious that other kind of fluorescent powders can also be used, and the present embodiment is not limited thereto.

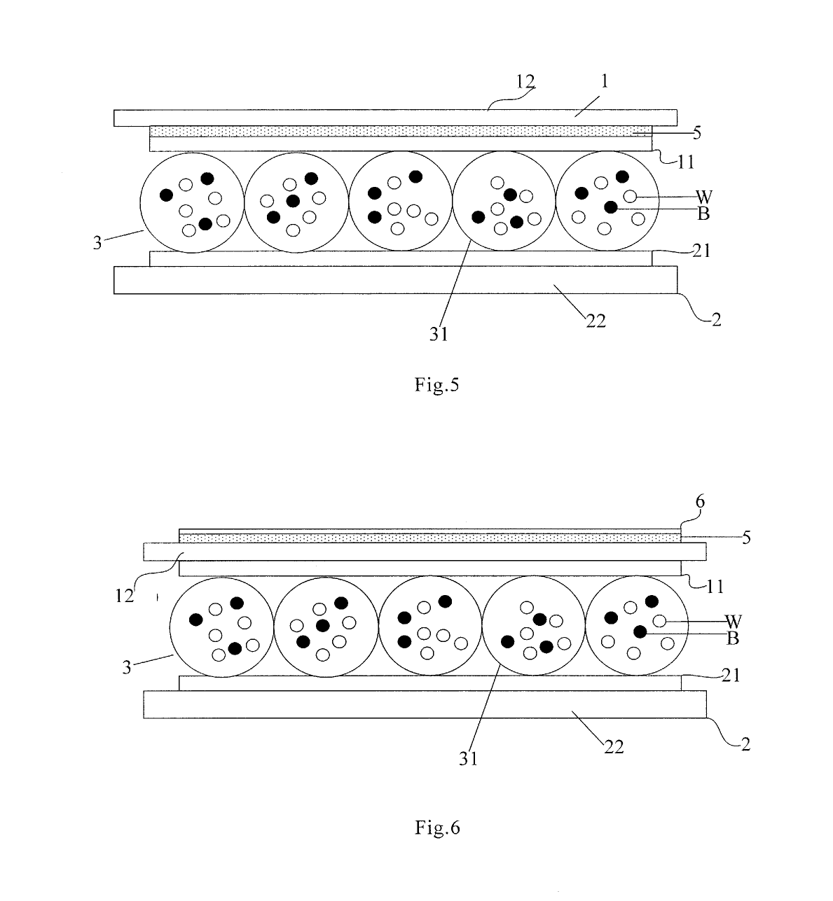

It should be noted that in the present application the fluorescent material layer 5 is not limited to be disposed between the base layer 12 and the first conductive layer 11; as shown in FIG. 6, the first conductive layer 11 is formed on the inner side of the base layer 12, and the fluorescent material layer 5 is disposed on another side (i.e., outer side) of the base layer 12. In this case, a protection layer 6 may be further provided on the fluorescent material layer 5 to prevent the fluorescent material layer 5 from breaking.

The user is in front of the substrate 1 when the display device is used.

Moreover, an embodiment of the disclosed technology further provides a displaying method of the electronic paper display device, which comprises the following steps.

Step 101 of displaying with ambient light while the fluorescent material disposed in the electronic paper display device receives irradiation of the ambient light to store optical energy; and

Step 102 of displaying by using light generated due to the optical energy discharging from the fluorescent material when the ambient light become weak or disappears.

In an example, the electronic paper display device according to the embodiment of the disclosed technology displays by using the ambient light and the light generated due to the optical energy discharging from the fluorescent powder when the ambient light become weak; and the display device displays by only using the light generated due to optical energy discharging from the fluorescent material when the ambient light disappears.

The present embodiment provides a displaying method of the electronic paper display device in which the electronic paper display device as described above displays by using ambient light and at the same time the fluorescent power receives the irradiation of ambient light to stores optical energy therein when the ambient light around thereof is sufficient, and the fluorescent material discharges the optical energy in the form of fluorescent light when the ambient light become weak or disappears so that the electronic paper display device can display by using the light generated due to the optical energy discharging from the fluorescent material. This method make uses of the property of the fluorescent material which stores optical energy when receiving irradiation of the ambient light and gradually discharging optical energy in fluorescent light form when the ambient light become weak or disappears. The electronic paper display according to the embodiment of the disclosed technology can normally display when the ambient light become weak or disappears.

It should be appreciated that the embodiments described above are intended to illustrate but not limit the disclosed technology. Although the disclosed technology has been described in detail herein with reference to the embodiments, it should be understood by those skilled in the art that the disclosed technology can be realized with different material and equipment as necessary, and that various modification and equivalents thereof can be made herein without departing from the spirit and scope of the disclosed technology.

What is claimed is:

1. An electronic paper display device comprising:
an upper substrate with a first conductive layer formed thereon;
a lower substrate with a second conductive layer formed thereon, and
an electronic ink layer disposed between the first conductive layer of the upper substrate and the second conductive layer of the lower substrate and comprising microcapsules arranged therein,
wherein a fluorescent material is further disposed between the upper substrate and the lower substrate, and the fluorescent material is disposed in a region between the upper substrate and the lower substrate where it is capable of receiving irradiation of ambient light.

2. The electronic paper display device of claim 1, wherein the fluorescent material comprises fluorescent particles enclosed within the microcapsules.

3. The electronic paper display device of claim 2, wherein the fluorescent material is upconversion fluorescent powders.

4. The electronic paper display device of claim 1, wherein the fluorescent material is disposed within capsule walls of the microcapsules.

5. The electronic paper display device of claim 4, wherein the fluorescent material is water-solution fluorescent powders.

6. The electronic paper display device of claim 1, wherein the upper substrate comprises a base layer, the first conductive layer is formed on a side of the base layer, and the fluorescent material is in a layer disposed between the base layer and the first conductive layer.

7. The electronic paper display device of claim 1, wherein the upper substrate comprises a base layer, the first conductive layer is formed on a side of the base layer, and the fluorescent material is in a layer disposed on another side of the base layer opposite to the first conductive layer.

8. The electronic paper display device of claim 6, wherein the fluorescent material is upconversion fluorescent powders.

9. The electronic paper display device of claim 7, wherein the fluorescent material is upconversion fluorescent powders.

10. A displaying method of an electronic paper display device comprising:
displaying with ambient light while fluorescent material disposed in the electronic paper display device receives irradiation of ambient light to store optical energy; and
displaying with light generated due to the optical energy discharging from the fluorescent material when the ambient light become weak or disappears.

11. The displaying method of claim 10, wherein displaying with light generated due to the optical energy discharging from the fluorescent material when the ambient light become weak or disappears comprises:
displaying with the ambient light and the light generated due to the optical energy discharging from the fluorescent material when the ambient light become weak.
